(19) United States
(12) Patent Application Publication
(10) Pub. No.: US 2003/0052146 A1
(43) Pub. Date: Mar. 20, 2003

(54) French fry holder for vehicles

(76) Inventors: Robert J. Magnuson, Escanaba, MI (US); Jerome Lueneburg, Gladstone, MI (US)

Correspondence Address: Richard C. Litman, LITMAN LAW OFFICES, LTD., P.O. Box 15035, Arlington, VA, 22215, US

(21) Appl. No.: 10/235,504

(22) Filed: Sep. 6, 2002

Related U.S. Application Data
(60) Provisional application No. 60/318,824, filed on Sep. 14, 2001.

(51) Int. Cl. B60R 7/06

(52) U.S. Cl. 224/483; 224/276

(57) ABSTRACT

A container for holding hot french fries. The container is provided with support structure to securely support the container from an interior surface of an automobile at a location in easy reach for the driver. As contemplated, the container will be supported from the lowest louvre of the automobile air vent. An elongate strip is adhesively fastened to the rear surface of and extends above the container. The strip is provided with a top portion which can be moved or opened to form a hook for securing the strip (and container) to the louvre. The strip is sized so that the container will be suspended below the air vent.

### CROSS-REFERENCE TO RELATED APPLICATION

This application claims the benefit of U.S. Provisional Patent Application Serial No. 60/318,824, filed Sep. 14, 2001.

### BACKGROUND OF THE INVENTION

1. Field of the Invention

The present invention generally relates to containers. More specifically, the instant invention is drawn to a container for holding french fries in an automobile.

2. Description of Related Art

Beside offering a mode of transportation as is its intended function, the modern automobile often functions as an office (digital phone), an entertainment center (stereo) and cafeteria (cup holder and console tray). Unfortunately, however, there never appears to be a convenient, safe place to put the hot, tasty french fries just purchased at the fast food drive-through window. An invention to solve this predicament would certainly be welcomed in the art.

The prior art is replete with holders for suspending beverage containers from the inside surfaces of automobiles. Examples of such prior art are disclosed in U.S. Pat. Nos. Des. 287,789 (Johnson), 2,698,155 (Bowman), 4,606,523 (Statz et al.), 4,779,831 (Anderson) and UK Patent Application 2,223,935 A. All of the above references utilize permanent-type plastic holders and contemplate suspending the holder directly from the dashboard or from the automobile door window sill.

U.S. Pat. No. Des. 425,854 (Matlack) shows a holder adapted to be supported from the air vent of an automobile (FIG. 10). The instant holder is designed to hold a doll and is made of a plastic material.

U.S. Pat. No. 4,852,843 (Chandler) is drawn to a beverage container holder adapted to be supported from the air vent of an automobile. Like the holders cited above, the instant holder is fabricated from a permanent-type plastic material.

U.S. Pat. No. 4,979,657 (Espiritu) discloses a portable beverage container made from cardboard. The container is fabricated of a single flat sheet having creases formed therein and requires assembly prior to use. Hook and loop fasteners are employed to suspend the container from the dashboard of an automobile.

U.S. Pat. No. 5,785,222 (Basso et al.) shows a holder having plural pockets for carrying various articles. The holder may be mounted to the automobile sun visor or door window sill. The holder is fabricated, in part, from metallic material.

U.S. Pat. Nos. Des. 306,975 (Brondyke et al.) and 6,152,362 show containers for holding french fries. There is no provision for supporting the containers from the inside surface of an automobile.

None of the above inventions and patents, taken either singly or in combination, is seen to disclose a disposable holder for french fries as will subsequently be described and claimed in instant invention.

### SUMMARY OF THE INVENTION

The present invention is drawn to a container for holding hot french fries, which container is provided with support structure whereby to securely support the container from an interior surface of an automobile at a location in easy reach for the driver.

As contemplated, the container will be supported from the lowest louvre of the automobile air vent. An elongate strip is adhesively fastened to the rear surface of and extends above the french fry container. The strip is provided with a top portion which can be moved or opened to form a hook for securing the strip (and container) to the louvre. The strip is sized so that the container will be suspended below the air vent. This arrangement prevents the container from impeding air flow and also prevents cool air from effecting the temperature of the hot fries. By being mounted on the air vent, the container is in the peripheral vision of the driver, thus allowing the driver to reach for a fry without taking his/her eyes from the road. The extended strip also functions as a serving and retrieving aid in that it permits the container of fries to be efficiently inserted and removed from a bag without touching the hot container and spilling the fries. Both strip and container are fabricated from easy-to-disposed-of biodegradable material.

Accordingly, it is a principal object of the invention to provide a food holder, which holder is mountable on an inside surface of an automobile.

It is another object of the invention to provide a holder for french fries.

It is a further object of the invention to provide a holder for french fries, which holder is mountable on the air vent of an automobile.

Still another object of the invention is to provide a holder mountable on an inside surface of an automobile, which holder is fabricated from biodegradable material.

It is an object of the invention to provide improved elements and arrangements thereof in a holder for the purposes described which are inexpensive, dependable and fully effective in accomplishing their intended purposes.

These and other objects of the present invention will become readily apparent upon further review of the following specification and drawings.

### BRIEF DESCRIPTION OF THE DRAWINGS

FIG. 1 is an environmental, perspective view of a french fry holder for vehicles according to the present invention.

FIG. 2 is a front view of a french fry holder according to the present invention.

FIG. 3 is a rear view of a french fry holder according to the present invention.

Similar reference characters denote corresponding features consistently throughout the attached drawings.

### DETAILED DESCRIPTION OF THE PREFERRED EMBODIMENT

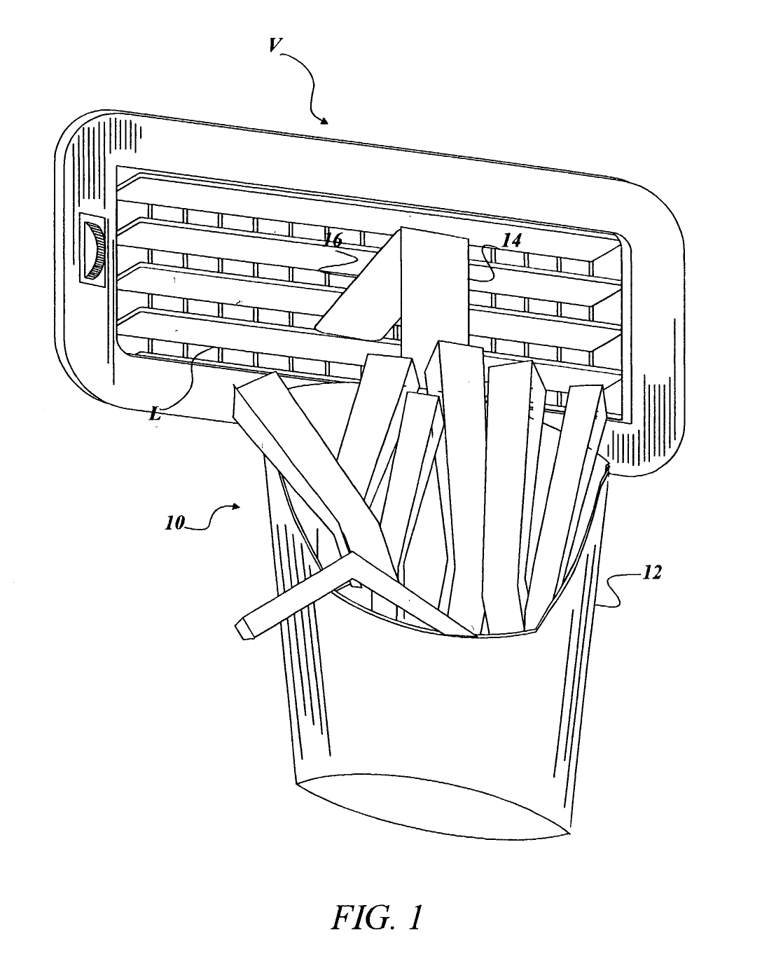

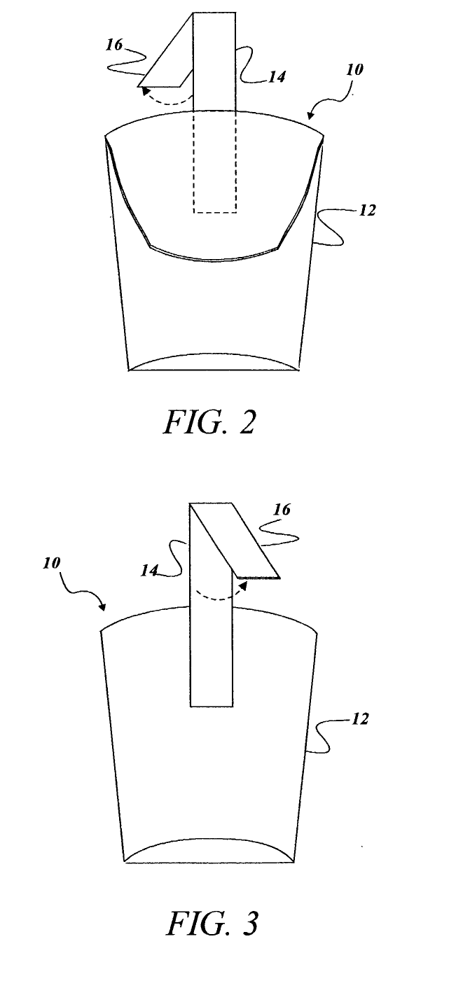

As illustrated in FIGS. 1-3, the french fry holder of the present invention is generally indicated at 10. Holder 10 comprises an open top container 12 fabricated from a biodegradable material such as a light to medium weight cardboard. The body of container 12 is imperforate and defines a volume adapted to hold an order of french fries. Container 12 can be made to various capacities so as to hold the popular sizes of french fry orders (small, medium, large, super, etc.).

An elongate thin strip member 14 is adhesively attached to the rear surface of container 12 and extends upwardly therefrom. Any suitable commercially available adhesive may be utilized to accomplish the attachment. Strip 14 is fashioned with a folded over upper end providing a tab portion 16. In its initial position, portion 16 lies adjacent to and in abutting relationship with strip 14. In use, portion 16 is swung outwardly, as indicated by the arrows, to form a hook. The hook is inserted in the automobile air vent V through an opening just above the lowest louvre L to engage the louvre L and thereby to suspend container 12 at a position just below air vent V. It has been determined that a strip 14 measuring approximately one-half of inch in width and three inches in length will adequately support the container in the desired position.

It is to be understood that the present invention is not limited to the sole embodiment described above, but encompasses any and all embodiments within the scope of the following claims.

We claim:

1. A holder for french fries, said holder adapted to be supported from a louvre of an air vent of an automobile comprising:
a container, said container having a front wall, a rear wall, a bottom wall and an open top;
an elongate strip attached to said rear wall of said container and extending above said open top, said elongate strip having an upper end;
an unfoldable tab member, said unfoldable tab member formed on said upper end of said elongate strip, whereby said tab member can be unfolded to attach said upper end of said strip to the louvre.

2. A holder for french fries as recited in claim 1, wherein said container is fabricated from biodegradable material.

3. A holder for french fries as recited in claim 2, wherein said strip is fabricated from biodegradable material.

4. A holder for french fries as recited in claim 4, wherein said tab member is fabricated from biodegradable material.

5. A holder for french fries as recited in claim 4, wherein said elongate strip is adhesively attached to said rear wall of said container.

6. A holder for french fries, said holder adapted to be supported from a louvre of an air vent of an automobile comprising:
a container, said container having a front wall, a rear wall, a bottom wall and an open top;
an elongate strip attached to said rear wall of said container and extending above said open top, said elongate strip having a length of three inches and having an upper end;
an unfoldable tab member, said unfoldable tab member formed on said upper end of said elongate strip, whereby said tab member can be unfolded to attach said upper end of said strip to the louvre.

7. A holder for french fries as recited in claim 6, wherein said elongate strip has a width of one-half of an inch.

8. A holder for french fries as recited in claim 7, wherein said container is fabricated from biodegradable material.

9. A holder for french fries as recited in claim 8, wherein said strip is fabricated from biodegradable material.

10. A holder for french fries as recited in claim 9, wherein said tab member is fabricated from biodegradable material.

11. A holder for french fries as recited in claim 10, wherein said elongate strip is adhesively attached to said rear wall of said container.
